(19) United States
(12) Patent Application Publication
(10) Pub. No.: US 2008/0034934 A1
(43) Pub. Date: Feb. 14, 2008

(54) Automated molding cut-off saw and method

(76) Inventors: Thomas C. Mekkelsen, Riverside, CA (US); Hector Rousseau, Riverside, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/503,757

(22) Filed: Aug. 14, 2006

(51) Int. Cl. B26D 5/20

(52) U.S. Cl. 83/76.9; 83/522.11

(57) ABSTRACT

Improvements in a cut-off miter saw for floor, wall, crown molding, wood, plastic, metal and the like are disclosed that includes an automated or manually fed cut-off saw where measurements are dynamically entered into a wireless communications device. The measurements are organized and sent to a cut-off saw where the material is cut with a first angle, indexed and cut at a second angle. The parts are further marked or organized and routed to the installer. This offers a tremendous improvement and reduction in the amount of time presently required to perform these operations in a serial order. It is particularly useful in measuring, cutting and nailing floor molding in houses, or other buildings where each room has slightly different dimensions and each length is custom fit.

### FIELD OF THE INVENTION

This invention relates to improvements a molding, wood, plastic or metal cut-off miter saw and method of use. More particularly, the present automatic saw includes an automated or manually fed cut-off saw for floor, wall crown molding wood, plastic, metal or the like where measurements are dynamically entered into a wireless communications device where the data is sent to the cut-off saw and the material is cut with a first angle, indexed and cut at a second angle. The parts are further marked or organized and routed to be installed.

### BACKGROUND OF THE INVENTION

When a room is finished the area around the outside floor is usually finished with a molding. Moldings are also often placed on the ceiling as crown molding or on the wall as chair railing. Presently most floor wall and crown molding are cut in a serial manner where first the dimensions of a room are measured and written down. The measurements are then taken to a cutting saw or station where the molding materials are cut to the identified lengths. The cut material is then transported to the room and laid around the room where it is nailed in position. This method is extremely time consuming. Rooms that are fabricated using the same plans often have differences in dimension. Each section of molding must be cut to a fairly precise dimension making this method of custom measurement and custom cutting necessary. A number of patents have issued on cutting machines for moldings or the like. Exemplary examples of these patents are disclosed below.

U.S. Pat. No. 3,665,983 issued to Andrew M. Kvalheim on May 30, 1972 discloses an Adjustable Trim Saw Apparatus for Miter Cuts and Saw Kerfs. This patent utilizes two separate saws intended primarily for use in cutting door jam moldings. Material is indexed into the machine and one blade cut the material to length while the other blade cuts a kerf into the jam molding. The distance between the blades is either manually adjusted or motor driven into the desired position. While this patent discloses two saw blades that cut opposite ends of a piece of molding the distance between the cutting saw blades is manually adjusted and the patent does not disclose using the blades to cut angular miter or compound angles. In addition there is no printing or marking capability to designate where the material is to be installed.

U.S. Pat. No. 3,854,360 issued to James C. Reed on Dec. 17, 1974 discloses a Self-Gauging Miter Saw. This saw utilizes a pattern and the disclosed patent uses the pattern to duplicate the size of the template or pattern part. The saw is not programmable and the material is not indexed through the machine. The blades are further fixed at a 45 degree angle. The product is most usable for cutting frames for windows, pictures, door molding or the like. In addition there is no printing or marking capability to designate where the material is to be installed.

U.S. Pat. No. 3,910,142 issued to John C. Jureit et al discloses an Automated Saw where the length and angle of cut is entered into the control system by manual entry or by loading the program onto a tape drive. Single or multiple cuts can be made to the material. All of the cuts are made in a perpendicular relationship to the length of the material. The data must be entered in advance and the control does not sort the data to determine the optimal length to cut each piece. In this patent the lengths are all pre-determined before the saw begins to cut the material. In addition there is no printing or marking capability to designate where the material is to be installed. The patent does not disclose using the blades to cut angular miter or compound angles

U.S. Pat. No. 6,216,574 issued to Leonard Hain on Apr. 17, 2001 discloses an Automated Stop Positioning System Apparatus. In this patent a stop moves to locate the length of the cut material. The operator is able to enter the desired length into the stop, and the stop will index to the desired position where the board is cut to length. This patent also does not allow for dynamic entry of variable length boards where the machine automatically indexes to accommodate the various lengths. It also does not include a printer/marker or allow for compound miter cutting angles.

What is needed is a single or dual cutting saw where measurements are dynamically entered at a distal location and the saw cuts one side, indexed and cut the other side, marking the location where the uniquely cut board is to be installed. The device would further include automated loading of material and collating of the cutting measurements to best utilize the material being w cut. The proposed saw for cutting molding, wood, plastic or metal material satisfies these requirements in a single unit.

### BRIEF SUMMARY OF THE INVENTION

It is an object of the automatic cut-off saw to provide an automatic saw for use in measuring and cutting elongated material such as floor wall and crown molding, wood, plastic or metal. The automated saw utilizes a measurement and data storage mechanism such as a hand held phone or PDA and the dimensions of a room are measured and entered into the device where they are communicated to the cutting saw. The input can have a voice entry of the data as measurements are taken, and further provide an audible announcing of the measurement to confirm the entered data. In the installation of the moldings on multiple “similar” rooms such as hotel rooms, the data storage device includes learning and verify mode where it prompts the user around a similar room to determine variations based upon wall inconsistencies. The data storage device further prompts the user for angles and variables where the dimensions and end cuts can be visually or audibly verified. The communication from the measurement/data storage device is with a wired or wireless link where the data is transferred to the saw and or a computer.

It is another object of the automatic cut-off saw for the saw to take the measurements and collate the data to maximize material utilization and minimize scrap. The material is the automatically indexed into the machine where a first and is cut into the material, the material is indexed to the next cutting location and the second cut is made to the material. The finished part can be optionally marked to indicate its intended location.

It is another object of the automatic cut-off saw for the saw to cut virtually any angle or combination of angles or compound miter angles on the en material. This also includes the ability of the saw to subtract or add material c>>thickness if the installed molding is created from multiple built-up moding t wood, plastic or metal pieces. The machine is also capable of making one or multiple kerf marks on material as well as thin an area on the molding to _ accommodate a local anomaly in the wall where the material is to be placed.

It is another object of the automatic cut-off that the saw performs a visual inspection of the material as it is being cut to reject or cut around identified material defects.

It is another object of the automatic cut-off saw for the saw to include a marking or printing device so cut material is installed in the location intended. The marking information is helpful in re-constructing where the parts were measure and are to be installed.

It is another object of the automatic cut-off saw for the saw to be powered by one or multiple power sources including but not limited to wall supplied AC power, air and batteries.

It is still another object of the automatic cut-off saw for the saw to include a bulk material loader where multiple uncut lengths are bulk loaded into a feeding mechanism and the material is individually indexed into the cutting saw.

It is still another object of the automatic cut-off saw where cut groups of molding, wood, plastic or metal are banded into a collective group for installation in a designated room where the measurement were taken.

It is still another object of the automatic cut-off saw where data storage device evaluates the entered data and checks for entry errors and prompts where potential errors are detected for verification.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows an isometric view of the automated molding cut-off saw according to a preferred embodiment.

FIG. 2 shows a block diagram of the typical method being used as prior art.

FIG. 3 shows a block diagram of the method of using the device according a preferred embodiment.

FIGS. 4A and 4B show screen shots from the input device or measurement tool.

FIG. 5 shows a detail view of the cut-off saw.

FIG. 6 shows an alternate embodiment of the molding cut-off saw using two saws.

### DETAILED DESCRIPTION

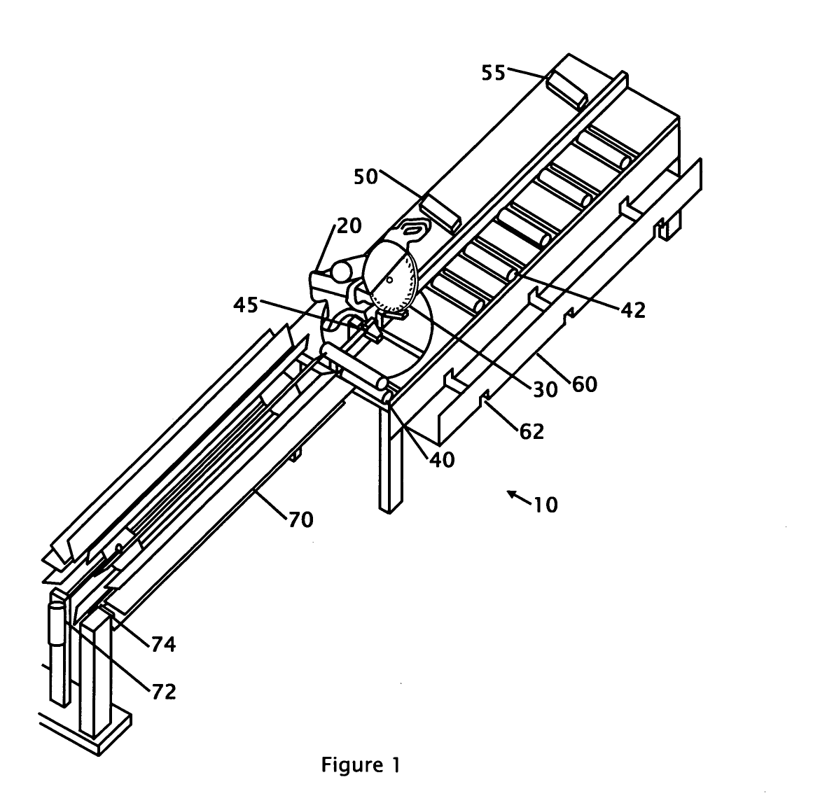

FIG. 1 shows an isometric view of the automated molding cut-off saw 10 according to a preferred embodiment. This view shows the overall molding cutting machine with its various components. A detailed view showing the elements around the saw is found in FIG. 5. The saw 20 is a combination type saw where the angle and tilt of the blade is adjustable to match the requirements for making miter cuts to floor, wall and crown molding. It is contemplated that the saw and feeding mechanism is powered by one or multiple power sources including but not limited to wall supplied AC power, air and batteries. In this figure a rotary material dispensing apparatus 70 is shown for feeding material into the cutting portion or blade of the machine. While in this description, moldings are predominantly indicated, it is contemplated that the automatic saw in use with the data recording and transfer system is equally suited for use with metal, wood, plastic and other elongated materials.

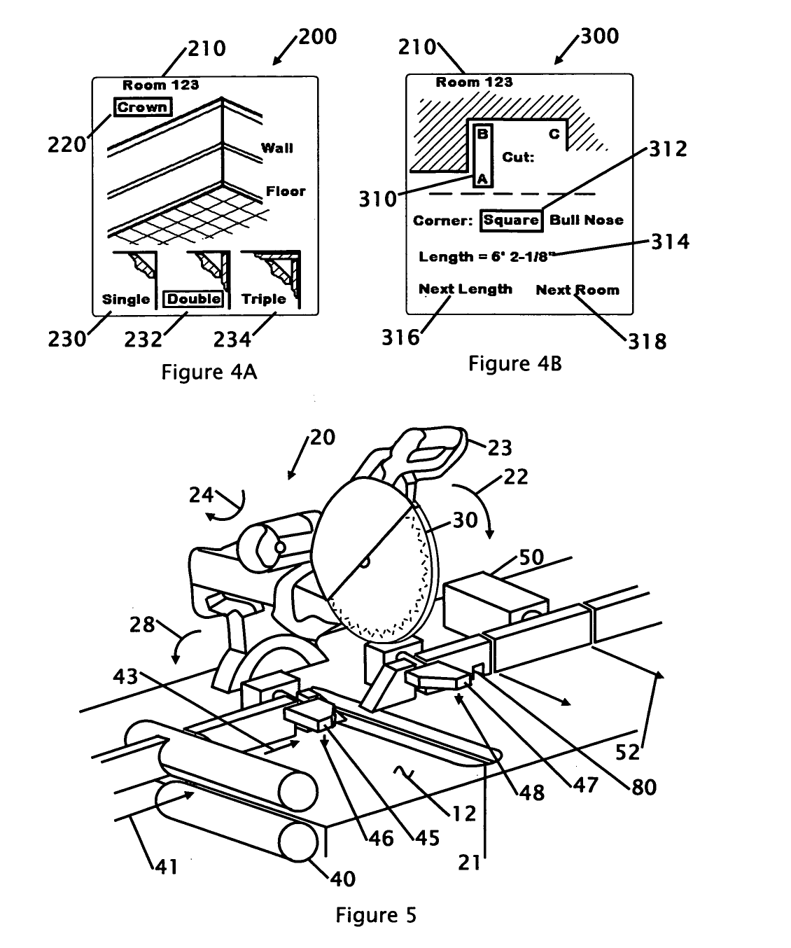

In this embodiment the dispensing apparatus 70 has retaining means for retaining up to 12 lengths of material. The quantity of 12 provides a preferred number of holders to provide material for a single double or triple type built-up molding that might be found in different molding installations. The single, double and triple configuration of installed moldings is described in more detail with FIG. 4A. The dispensing apparatus 70 indexes with a motor or mechanism 72 to locate the desired material held in the apparatus at the height of the cutting surface. When the material is at the height of the cutting surface a pusher 74, pushes the material from the dispensing apparatus 70 onto the cutting table where it is gripped with locating and feeding wheels 40 that both measure the length of material that is being feed and push the material under and past the cutting blade 30. After a first cut, the material is indexed and measure for the second cut. The indexed material rolls over the table surface or on rollers 42 placed in the table surface. A marking apparatus that is shown and described in FIG. 5 marks or otherwise identifies each cut length. The operation continues for the second cut. The cut material is then pushed off the cutting table with pushers 50 and 55 into a collecting or wrapping bin 60. The bin 60 has slots 62 for bringing wrapping material around the items in the bin to keep then in a collective group.

Operation of the Cutting Machine

This operation of the cutting machine describes to operation for cutting of a single length of material. In normal operation the data of multiple cuts is collated to best use the material and minimize waste. Material is fed into the cutting machine from the dispensing apparatus 70 by pusher 74.

When the material is in the desired location clamps 45, located on one or both sides of the cutting blade 30, hold the molding material while it is being cut. In this configuration with a single cutting blade, the new length of molding material is fed into the cutting portion until the blade can make one or more a complete cut of the material. It is possible that between successive cuts that the material may be in the correct position or that the material may need to be slightly backed out of the cutting area. The material is clamped 45. The blade is rotated or tilted until it reaches the correct orientation. The blade 30 is started and passed through the molding material and returns to a position off of the molding. The clamp(s) 45 are released. The material is driven and measured with wheel(s) 40. As the material is being moved it passes by a printing, marking or other indicating apparatus (shown in FIG. 5) for identification of where the section of molding is to be placed.

When the material is in position for the next cut, the clamp(s) 45 hold the molding material. The blade is rotated or tilted until it reaches the correct orientation. The blade 30 is started and passed through the molding material and returns to a position off of the molding. The clamp(s) 45 are released. One or more pushers 50, 55 push the cut and marked material into bin 60. Scraps or remnants are either pushed off of the table as the length is pushed off the table, or is blown from under and around the blade.

It is also contemplated that the material be indexed finite positions between the two cuts and the blade brought partially through the molding to provide one or more kerfs to make bending that wood easier. In a further contemplated operation, the material is indexed to one or more specific positions where the blade removes some material from the molding to provide clearance or an anomaly along the wall or for clearance of wires, pipes or similar features. It is further contemplated that the material is visually inspected as it is being fed under the saw and defects or Imperfections in the material are cut around or discarded.

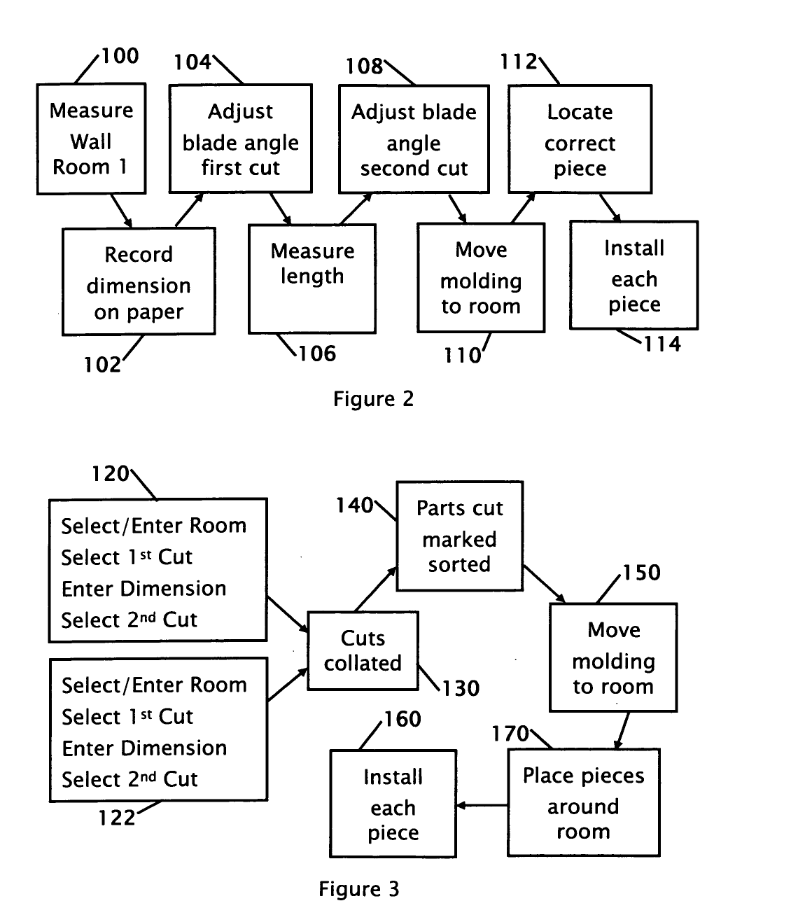

FIG. 2 shows a block diagram of the typical method being used as prior art. This method will be described in brevity to provide understanding of the current method and the benefits associated with the proposed molding cutting system. The operation is generally performed by one person with one or more helpers and the measurement and cutting involves primarily accurate measurements, but some art and experience is involved, especially where difficult corners or miters are involved. Each wall is first measured 100. The measurements are recorded, usually on paper. The person measuring may alternatively make a sketch of the room or use architectural drawings where they enter the actual lengths of each room 102. The measurements are then taken to a miter saw where the blade is set to a first cut 104. In a simple room requiring only floor molding with square miter corners only two opposed 45 degree angle cuts are required. In a more complex installation with triple-crown molding, bull nose edges, and some walls that are not 90 degree angles, a large number of different angular cuts are required, each with different angle settings.

The length 106 of the molding is marked on the molding and the blade angle is set. Newer compound miter cutting saws incorporate a laser with the cutting blade making it easier to determine where the kerf of the blade will be made prior to making the cut. The angle and or miter are manually set on the saw 108 and the piece of molding is cut at the indicated length 108. This operation continues where the blade is set to a first angle, the part is cut, measured, and the blade is set to second angle and cut again until a group of parts are cut, or each part is individually cut and moved to the room 110 where it is located 112 in order. The moldings are then installed and nailed in place 114. While only one cut per side of the molding is disclosed, it is contemplated that multiple cuts can be made to each end of the molding.

FIG. 3 shows a block diagram of the method of using the device according a preferred embodiment. One or more workers can work independently in different rooms 120 and 122. The measurements and cuts are entered into an input device that Is shown and described in more detail with FIGS. 4A and 4B. The information is transmitted to the automatic molding cutting machine that collates the cuts 130 determines the optimal order to cut the material for the best utilization. When a sufficient amount of cuts is entered or all measurements are entered for the material, the machine automatically loads the material, sorts the cuts, cuts the parts, and marks the parts 140. The person that measured the room can move the moldings to the designated room, or an unskilled apprentice worker can move the material and place the parts around the room based upon the identification on each part 170. The parts are then set and-nailed in position. The advantage is in setting the saw for the various cutting angles, marking the parts for accurate placement in a specific room, and efficient utilization of the lengths of moldings. The speed and repeatability of setting the angles and measuring the lengths is greatly improved, as well as the ability to complete installation in a reduced period of time.

FIGS. 4A and 4B show screen shots from the input device or measurement tool. These screen shots show some contemplated display and selection information. These are screens that appear on a PDA with wireless or wired connectability to transmit data to the cutting station. They could also appear on a cell phone, or be integrated into a tape measure, or ultrasonic measuring tool. The input can have a voice entry of the data as measurements are taken, and further provide an audible announcing of the measurement to confirm the entered data. In FIG. 4A the user visually sees the information on the screen 200 and selects with keys, stylus or finger the type of job. The specific location or room, in this case Room 123, 210 is entered. Additional information or alternative information can also be visible such as “bedroom”, “living room” or other such designation. The type of installation is for crown molding 220, but the other options for floor, and wall molding is also shown as available. Since crown molding was selected, three types of crown molding is available, single 230, double 232 and triple 234 with a graphic showing the installation type. The user has selected a double 232 for the installation. When the molding is being cut by the machine, it will cut separately both the backer and the crown section for each wall, and will account for the thickness of the backer in corners automatically based upon the thickness parameters for the backer(s).

With the type of installation selected, a small diagram 300 will allow the user to enter or measure the distance along with designation of the part being used for an inside miter corner wall B-C or an outside miter corner wall A-B. The room 123 (210) is still shown to reduce the possibility of confusion for measurements and cuttings. In this screen shown, an outside miter corner wall A-B is shown selected 310. The wall corners are selected a square 312 as opposed to bull nose that usually requires an extra molding piece on outer miter corners. The length of wall A_B is entered, or if the input device is integrated in a tape measure, the tape measure is extended to the length of the wall 314, and an enter button is selected so the measurement is stored. The operator can then select another length or wall 316, or they can select another room 318. The input device can compare measurements from similar rooms to check for errors and or prompt for similar measurements. The data is transferred to the cutting machine either one measurement at a time or as a collective room when all measurements are taken. All the measurements can further be downloaded into a computer for additional analysis, billing or material purchasing.

FIG. 5 shows a detail view of the cut-off saw 20. Material is fed 41 into the drive/measurement wheels 40 where it slides 43 on the table 12. The blade 30 is adjusted for miter 24 of the blade 30 and or the compound miter cut angle 28. The molding material is moved until it sufficiently enters to ensure a complete cut of the material. The material is clamped with clamps 45 and or 47 that move down or in 46 and 48 to hold the parts while they are being cut. The blade 30 is rotated 22, and the blade is brought to cut through the molding. A slot 21 provides clearance for the blade to pass completely through the molding. While this operation of feeding, angular adjustment and cutting is automatically performed, a manual handle 23 is provided to allow for manual operation of the cutting to account for minor cutting, trimming or fitting of some pieces if required.

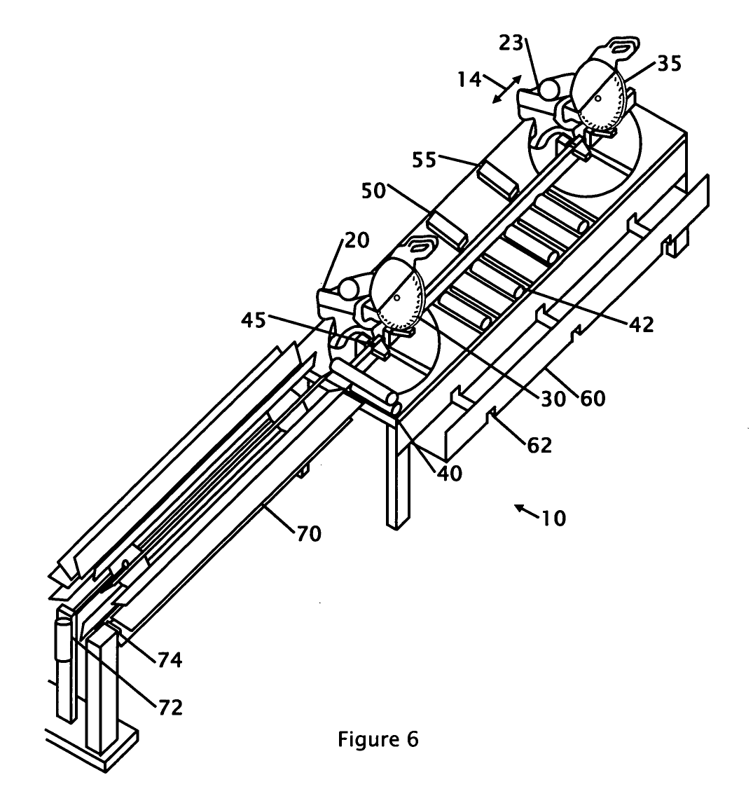

Indicating apparatus 80 prints, marks or otherwise places identification of where the section of molding is to be placed. In one contemplated embodiment the marking sprays ink onto the molding as it moves past the indicating apparatus. Ink or paint has the advantage of being wiped off or painted over, and can be placed on any side of the material. Ink has the disadvantage of clogging in the intended environment and must be filled. In the preferred embodiment the marking is with printing heads or pins that inscribe information into the material as it passes the indicating apparatus. This method of marking has the advantage of not requiring any ink and is permanent with the exception of sanding the mark off the molding. It has the disadvantage that it should only be applied to a non-cosmetic surface. Subsequent cuts are preformed in the same or similar manner as previously described until the part is cut free from the length of molding material. The finished and marked length is then pushed 52 with one or more pushers 50 that moves the material off the cutting table 12 and into a tray that is shown and descried in FIGS. 1 and 6.

FIG. 6 shows an alternate embodiment of the molding cut-off saw 10 using two saws 20 and 23. The components used in the two saw configuration are similar to the components previously described with the exception of a second cutting station 23 having a second blade 35 that in addition to adjusting angle and miter, the cutter translates 14 on the table allowing both ends of the material to be cut at the same time. The dispensing apparatus 70 indexes with a motor or mechanism 72 to locate the desired material held in the apparatus at the height of the cutting surface. When the material is at the height of the cutting surface a pusher 74, pushes the material from the dispensing apparatus 70 onto the cutting table where it is gripped by wheels 40. Locating and feeding wheels 40 both measure the length of material that is being feed and push the material under and past the cutting blade 30.

The material rolls over the table surface or on rollers 42 placed in the table surface. A marking apparatus that is shown and described in FIG. 5 marks or otherwise identifies each cut length. When the material is in position the material is clamed 45 and cut with the two saws. The cut material is then pushed off the cutting table with pushers 50 and 55 into a collecting or wrapping bin 60. The bin 60 has slots 62 for bringing wrapping material around the items in the bin to keep then in a collective group.

Thus, specific embodiments of an automated molding cut-off saw and method have been disclosed. It should be apparent, however, to those skilled in the art that many more modifications besides those described are possible without departing from the inventive concepts herein. The inventive subject matter, therefore, is not to be restricted except in the spirit of the appended claims.

1. An automatic cut-off machine comprising:
a measurement tool;
an input device for entering the data from the measurement tool;
a programmable cutting apparatus;
a communications link from the input device and the programmable cutting apparatus such that,
the data from the measurement tool is transferred to the programmable cutting apparatus and molding material is fabricated according to the measured and entered data.

2. (canceled)

3. (canceled)

4. The automatic molding cut-off machine according to claim 1 wherein the communications link is wireless.

5. The automatic molding cut-off machine according to claim 1 wherein the input device is capable of storing parameters including at least one of length, at least one angle, room and location.

6. The automatic molding cut-off machine according to claim 1 wherein the data from the measurement tool is collated to optimize use of the molding material and minimize waste.

7. The automatic molding cut-off machine according to claim 1 that further includes a printer that marks indicia on the molding material to correspond with the location where the measurement was taken.

8. (canceled)

9. The automatic molding cut-off machine according to claim 1 wherein the programmable cutting apparatus cuts square, angle, compound, miter, angular cuts and a combination thereof.

10. (canceled)

11. The automatic molding cut-off machine according to claim 1 wherein the programming of the programmable cutting apparatus includes the transfer of data from the input device to the cutting apparatus.

12. (canceled)

13. The automatic molding cut-off machine according to claim 1 wherein the programmable cutting apparatus can adjust the cutting dimensions to accommodate multiple stacked moldings.

14. The automatic molding cut-off machine according to claim 1 wherein the entry of data into the input device is with voice or audible commands.

15. (canceled)

16. (canceled)

17. The automatic molding cut-off machine according to claim 1 wherein the measurement device and the input device are the same device.

18. The automatic molding cut-off machine according to claim 1 wherein the input device prompts a user visually or audibly to ensure all pertinent data is entered and minimizes errors.

19. (canceled)

20. The automatic molding cut-off machine according to claim 1 wherein that further includes a method of using the automatic molding cut-off machine.
